(19) United States
(12) Patent Application Publication
(10) Pub. No.: US 2002/0164062 A1
(43) Pub. Date: Nov. 7, 2002

(54) Virtual radiological comparative assessment

(76) Inventor: George H. Newman, Niceville, FL (US)

Correspondence Address: William G. Auton, ESC/JAZ, 40 Wright Street, Hanscom AFB, MA, 01731-2903, US

(21) Appl. No.: 09/849,897

(22) Filed: May 7, 2001

(51) Int. Cl. G06K 9/00

(52) U.S. Cl. 382/132

(57) ABSTRACT

A patient receives a baseline medical image. The image is either a digital product or scanned/converted to a digital image and stored as a computer file for future use. When this patient receives subsequent imagery, the radiologist loads the baseline image file into a computer along with the new image file. The radiologist then runs a program on the computer that compares, bit-by-bit, the two digital images and identifies and highlights all differences between the two. The product of this process provides the radiologist with near instantaneous imagery changes that may be too small for the naked eye to identify.

### STATEMENT OF GOVERNMENT INTEREST

The invention described herein may be manufactured and used by or for the Government for governmental purposes without the payment of any royalty thereon.

### BACKGROUND OF THE INVENTION

The present invention relates generally to radiology and more specifically to a process that uses a computer to compare digital/digitalized medical images (MRI/CT/X-ray, etc.) to identify minute tissue changes. The purpose is two-fold: First, the process identifies minute changes between images that a trained radiologist could easily miss; and second, the process allows a radiologist to read and accurately assess substantially greater number of images during a given work cycle.

Diagnostic mammography is a powerful tool for early detection of precancerous features in breasts. Historically, breast screening using X-rays was performed using radiographic film, without an intensifying screen. Although the method provided very high spatial resolution of breast features, a very high radiation dose to the patient was required to expose the film. Therefore, it is important to immediately and accurately be able to detect changes in previous test results to avoid unnecessary duplicative tests.

Radiologists currently use their eyes to “read” medical images and identify related tissue abnormalities. This process is totally reliant upon the radiologist's expertise, attention to detail (impacted by fatigue and/or mental state), and limits of human capability. The radiologist is physically limited to the number of images he/she can assess in a given workcycle. However, the number of images requiring image-reading continues to challenge his/her capabilities, where one failure to accurately assess could result in lethal consequences.

The task of providing a comparative radiology diagnostic process is alleviated to some extent, by the systems of the following U.S. Patents, the disclosures of which are incorporated herein by reference:

U.S. Pat. No. 5,124,558, Jun. 23, 1992, Imaging system for mammography employing election trapping materials, Solitani, Peter K; and

U.S. Pat. No. 4,563,768, Jan. 7, 1986, Mammographic device using localized compression cone, Read, mark E.

While these references are instructive, they can be improved by the process of the present invention.

### SUMMARY OF THE INVENTION

The present invention is a process that uses a computer to compare digital/digitailized medical images (MRI/CT/X-ray, etc.) to identify minute tissue changes. The purpose is two-fold: images (MRI/CT/X-ray, etc.) to identify minute changes. The purpose is two-fold: First, the process identifies minute changes between images that a trained radiologist could easily miss; and second, the process allows a radiologist to read and accurately assess substantially greater number of images during a given work cycle.

An example of this process is as follows: A woman receives a baseline mammography. This mammography is either a digital product or scanned/converted to a digital image and stored as a computer file for future use. Five years later, this woman undergoes her second mammography. The radiologist loads the baseline mammography image file into a computer along with the new mammography image file. The radiologist then runs a program on the computer that compares, bit-by-bit, the two digital images and identifies and highlights all differences between the two. The product of this process provides the radiologist with near instantaneous imagery changes that may be too small for the naked eye to identify—changes that may be the first imagery indications of cancer.

It is an object of this invention to accurately and quickly compare medical images (MRI/CT/X-ray, etc.) to identify minute tissue changes. This purpose is two-fold: : First, the process identifies minute changes between images that a trained radiologist could easily miss: and second, the process allows a radiologist to read and accurately assess substantially greater number of images during a given work cycle.

### DESCRIPTION OF THE DRAWINGS

FIG. 1 is an illustration of a prior art system that can use the invention;

FIG. 2 is a diagram of the process steps of the invention

### DESCRIPTION OF THE PREFERRED EMBODIMENT

The present invention is a process that uses a computer to compare digital/digitalized medical images (MRI/CT/X-ray, etc.) to identify minute tissue changes. The purpose is two-fold: images (MRI/CT/X-ray, etc.) to identify minute changes. The purpose is two-fold: First, the process identifies minute changes between images that a trained radiologist could easily miss; and second, the process allows a radiologist to read and accurately assess substantially greater number of images during a (given work cycle.

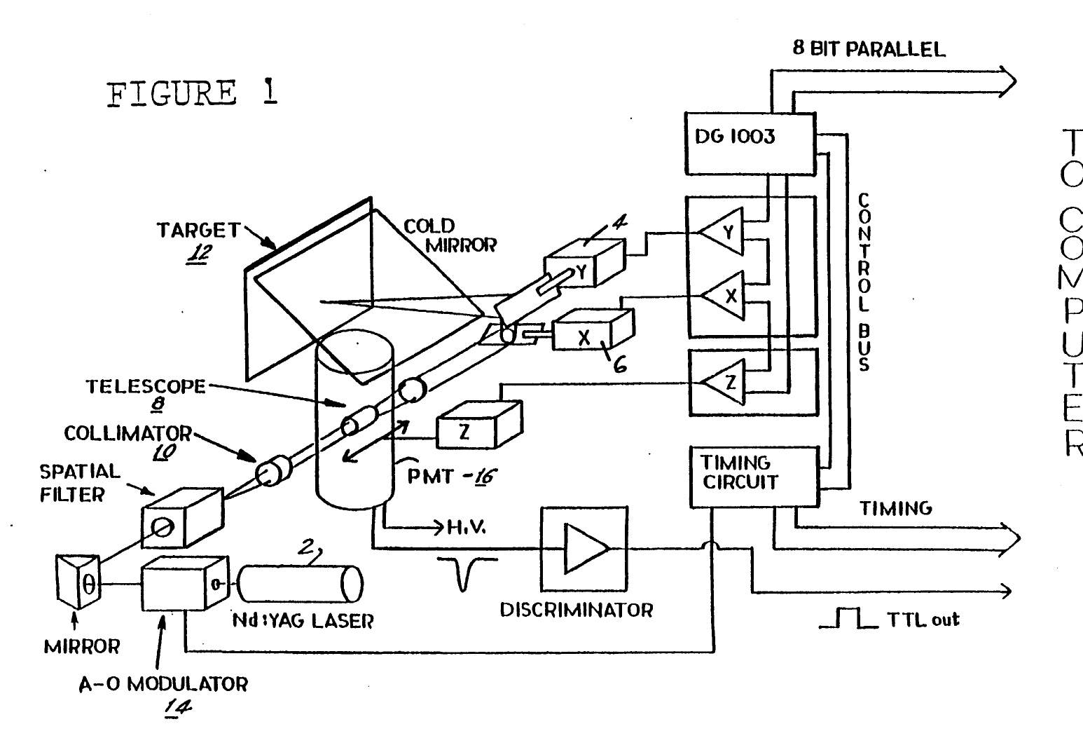

The reader's attention is now directed towards FIG. 1, which is a prior art high resolution photostimulable storage phosphor screen imaging system for breast imaging using X-rays. The phosphor material for storing the image, SrS; Ce, Sm, is appropriately milled to a fine powder and dispersed, using appropriate methods, with high particle packing, density, on a supporting substrate. The coated substrate forms a planar imaging screen for mammography. The phosphor screen of the present invention can record high quality digital (as opposed to analog,) images for diagnostic breast imaging.

In FIG. 1, the scanner system consists of a 50 mW diode pumped Nd: YAG laser 2 emitting 1.064 m wavelength. Scanning mirrors 4, 6 are used to step the IR beam and focusing optics 8, 10 are used to produce a beam size of 45 mu m(1/e,2.) at the phosphor screen. An acousto-optic modulator 14 is used to set the IR beam dwell time per pixel. The visible luminescence emitted by the phosphor screen during IR stimulation is collected and propagated to a photomultiplier tube 16 (PMT). The PMT signal is then digitized and stored in computer memory as a function laser beam position on the screen. Once an entire screen 12 is scanned in this way, the stored data is processed and displayed on a CRT as an image, where the magnitude of the PMT signal from each screen pixel is converted into a suitable gray level for display. Although the scanning system shown involves a 2-dimensional scan of the beam across a stationary screen it is also possible to scan the screen by other methods, such as single-axis beam raster and screen translation in an orthogonal direction.

The phosphor screen can be erased by simply flooding the screen with high intensity IR light to release all electrons from their traps.

The above-described system is presented as an example, and many modifications are possible. For example, laser diodes can be used in place of the Nd: YAG laser to supply IR light. Likewise, silicon photodetectors can be employed in place of the PMT to detect the visible light emission from the material.

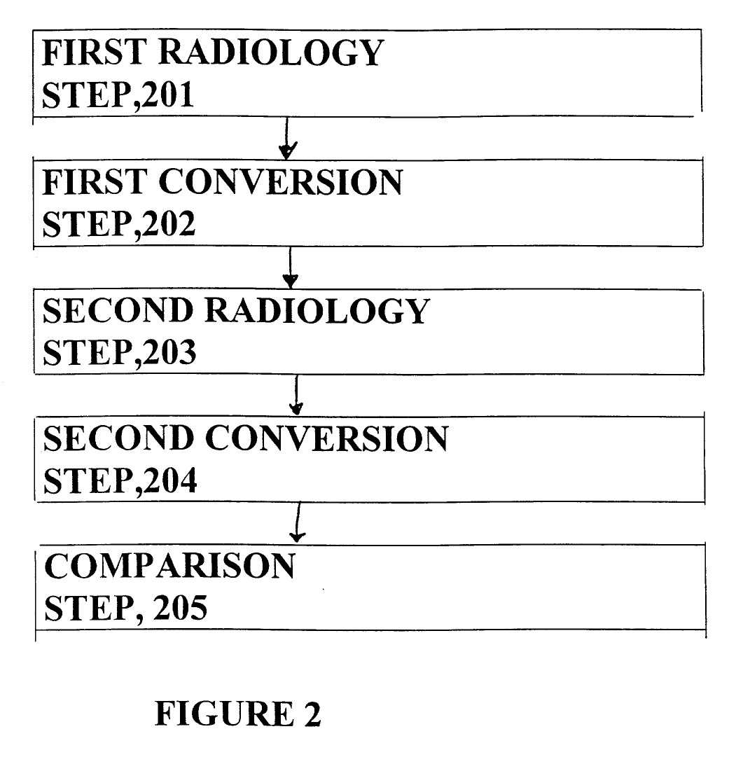

The system of FIG. 1 can use the process of the present invention as shown by the process steps of FIG. 2, as follows:

A patient receives a baseline medical image. The image is either a digital product or scanned/converted to a digital image and stored as a computer file for future use. When this patient receives subsequent imagery, the radiologist loads the baseline image file into a computer along with the new image file. The radiologist then runs a program on the computer that compares, bit-by-bit, the two digital images and identifies and highlights all differences between the two. The product of this process provides the radiologist with near instantaneous imagery changes that may be too small for the naked eye to identify.

The present invention enhances all radiological services in accuracy, timeliness, and productivity through computer imagery comparison application. It enables earliest tumor identification when comparative imagery is available—the result is substantially earlier cancer diagnosis and treatment, with resulting reductions in both patient treatment costs and mortality.

With the advent of low cost-high powered computers with extensive data storage capacity, there is no human alternative that can prove as efficient and effective in accurately comparing medical images and identifying minute changes between them.

FIG. 2 illustrates the present invention process. It is a comparative radiology diagnostic process made up of five steps. The first step is a first radiology step, in which a patient is scanned by a radiology device to produce a first analog image of an area of interest.

The second step, 202, is a first conversion step in which the first analog image is converted into a first digital image signal which may be stored in a computer.

The third step of the process is a second radiology step in which the patient is scanned by the radiology device to produce a second analog image of the area of interest.

The fourth step of the process is a second conversion step in which the second analog image is converted into a second digital image signal, which may be stored in the computer.

The fifth step is a comparing step in which the computer identifies changes in the area of interest by comparing the first digital image signal with the second digital image signal, to detect changes thereby.

The third through fifth steps may be repeated in subsequent visits by the patient.

While the invention has been described in its presently preferred embodiment, it is understood that the words which have been used are words of description rather than words of limitation and that changes within the purview of the appended claims may be made without departing from the scope and spirit of the invention in its broader aspects.

What is claimed is:

1. A comparative radiology diagnostic process comprising the steps of:
a first radiology step, in which a patient is scanned by a radiology device to produce a first analog image of an area of interest;
a first conversion step in which the first analog image is converted into a first digital image signal which may be stored in a computer;
a second radiology step in which the patient is scanned by the radiology device to produce a second analog image of the area of interest;
a second conversion step in which the second analog image is converted into a second digital image signal, which may be stored in the computer; and
a comparing step in which the computer identifies changes in the area of interest by comparing the first digital image signal with the second digital image signal, to detect changes thereby.

2. A comparative radiology diagnostic process, as defined in claim 1, wherein the first and second radiology steps are performed using an X-ray machine on the area of interest of the patient.

3. A comparative radiology diagnostic process, as defined in claim 1, wherein the first and second radiology steps are performed using an MRI machine on the area of interest of the patient.

4. A comparative radiology diagnostic process, as defined in claim 1, wherein the first and second radiology steps are performed using a Computerized Axial Tomography machine on the area of interest of the patient.
